(19) United States
(12) Patent Application Publication
(10) Pub. No.: US 2025/0189358 A1
(43) Pub. Date: Jun. 12, 2025

(54) METHOD AND DEVICE FOR MONITORING THE FILLING LEVEL OF A MEDIUM IN A CONTAINER

(71) Applicant: Endress+Hauser SE+Co. KG, Maulburg (DE)

(72) Inventors: Armin Wernet, Rheinfelden (DE); Kaj Uppenkamp, Wehr (DE); Benjamin Monse, Vogtsburg (DE)

(21) Appl. No.: 18/840,167

(22) PCT Filed: Jan. 31, 2023
(86) PCT No.: PCT/EP2023/052228

§ 371 Date: Aug. 21, 2024

(30) Foreign Application Priority Data
Feb. 23, 2022 (DE) 10 2022 104 249.9

(51) Int. Cl. G01F 23/263; G01F 23/24; G01N 27/22

(52) U.S. Cl. CPC G01F 23/266; G01F 23/24; G01N 27/221; G01N 27/226

(57) ABSTRACT

A method for determining and/or monitoring at least one process variable of a medium in a containment using a measuring probe having two electrodes comprises,
in a first operating mode, supplying a first electrode of the measuring probe with a first excitation signal, wherein a second electrode of the measuring probe serves as receiving electrode, and wherein a first received signal is received from the measuring probe,
in a second operating mode, supplying the first electrode of the measuring probe with a second excitation signal, wherein the second electrode of the measuring probe serves as ground electrode, and wherein a second received signal is received from the measuring probe, and
ascertaining the at least one process variable based on the first and/or second received signal.

Further disclosed is a device embodied for performing a method of the invention.

The invention relates to a method for determining and/or monitoring at least one process variable of a medium in a container with at least one measuring probe having at least two electrodes, as well as to a device for performing the method of the invention.

The process variable is, for example, a fill level of a medium in the container, the electrical conductivity of the medium or the permittivity of the medium. In the case of a fill level measurement, such can involve both a continuous fill level determination as well as also the detecting of a predeterminable limit level. The containment is, in turn, for example, a container or a pipeline.

Field devices based on the capacitive and/or conductive measuring principle are known per se in the state of the art and are manufactured and sold by the applicant in many different embodiments. Capacitive, or conductive, measuring devices have frequently an essentially cylindrical measuring probe having at least one electrode, which is introduced, at least partially, into a containment. On the one hand, especially, for continuous fill level measurement, rod shaped measuring probes extending vertically into the container are widely used. Known for detecting a limit level, however, are also measuring probes introducible into the side wall of a container and, especially, also such, which mount essentially flushly with the container wall.

During measurement operation, the measuring probe, especially a transmitting electrode of the measuring probe, is supplied with an excitation signal, as a rule, in the form of an alternating current signal. From the response signal received by the measuring probe, then the process variable of interest can be determined. In the case of the capacitive measuring principle, the dependence of the response signal on the capacitance of a first electrode of the measuring probe with the wall of the container or a capacitor formed by an additional electrode of the measuring probe is taken into consideration, in order to ascertain the desired process variable. Depending on conductivity of the medium, either the medium or an insulation of the measuring probe can form the dielectric of the capacitor.

For evaluating the response signal received by the measuring probe, frequently an apparent electrical current measurement or an admittance measurement is performed. In the case of an apparent electrical current measurement, the magnitude of the apparent electrical current flowing through the sensor unit is measured. The apparent electrical current includes, however, an active- and a reactive part. Therefore, in the case of an admittance measurement, besides the apparent electrical current, the phase angle between the apparent electrical current and the voltage applied to the measuring probe is measured. The additional determining of the phase angle enables, moreover, gaining information concerning possible accretion formation, such as is known, for example, from DE102004008125A1.

In the case of the conductive measuring principle, in contrast, it is detected, whether a conductive medium creates an electrical contact between one of the electrodes and the wall of a conductive container or the second electrode.

Field devices in the form of multisensors, which can operate both in a capacitive as well as also in a conductive operating mode, are known, for example, from DE102011004807A1, DE102013102055A1 and DE102014107927A1. Besides the fill level as process variable, various medium specific properties can be determined by means of such a multisensor, properties such as the electrical conductivity of the medium, or dielectrical properties of the medium, such as the dielectric constant. A corresponding sensor is described, for example, in DE102013104781A1.

A well known problem with capacitive and/or conductive field devices is the forming of accretions on the field measuring probe. This can significantly corrupt the measurement results. For preventing accretions, on the one hand, an as high as possible frequency can be selected for the excitation signal, since the corrupting influence of accretion basically decreases with increasing frequency of the excitation signal. Constructing a field device electronics suitably for high frequencies, is, however, on the one hand, associated with an increased degree of complexity. Moreover, the additional cost factor for the required components is not negligible.

Alternatively, a supplemental electrode, especially a so-called guard electrode, is used, such as described, for example, in DE3212434C2. The guard electrode is arranged, in such case, coaxially around the transmitting electrode and electrically isolated from such by an insulation. It is kept, furthermore, at the same potential as the transmitting electrode.

The gain in accuracy of measurement by an additional guard electrode depends, however, on the one hand, on the thickness of an accretion layer, as well as on the conductivity of the accretion. Especially in the case of conductive accretions, at lower frequencies of the excitation signal, resistive components of the accretion dominate the high-ohm measurement impedance ascertained based on the received signal. Usually the desired process variable is determined based on such impedance. Moreover, the effect of the guard electrode is limited by the relatively high impedance of an isolation capacitance of the measuring probe. Thus, in principle, no constant accuracy of measurement can be achieved by the guard electrode independently of the medium and its inclination for forming accretions, when high frequencies for the excitation signal should be avoided.

Starting from the above information, an object of the invention is to improve the accuracy of measurement of corresponding field devices independently of investigated medium.

The object is achieved by the method as defined in claim 1, as well as by the apparatus as defined in claim 15.

Regarding the method, the object of the invention is achieved by a method for determining and/or monitoring at least one process variable of a medium in a containment with at least one measuring probe, which measuring probe has at least two electrodes, comprising method steps as follows:
in a first operating mode, supplying a first electrode of the measuring probe with a first excitation signal, wherein a second electrode of the measuring probe serves as receiving electrode, and wherein a first received signal is received by the measuring probe,
in a second operating mode, supplying the first electrode of the measuring probe with a second excitation signal, wherein the second electrode of the measuring probe serves as ground electrode, and wherein a second received signal is received by the measuring probe, and
ascertaining the at least one process variable based on the first and/or second received signal.

The method of the invention can, in such case, be applied for all types of measuring probes suited for the capacitive and/or conductive measuring method.

According to the invention, the first electrode serves as transmitting electrode and the second electrode is either a receiving electrode or a ground electrode used. The ground electrode can be formed by a container wall.

By implementing the two sensor operating modes, a ground referenced operating mode and a non ground referenced operating mode, it is possible to ascertain the process variable without the influence of parasitic capacitances. This leads to an improved measuring resolution. Additionally, a significantly exact determining of accretion in the field measuring probe is possible.

The solution of the invention is especially advantageous in connection with measuring probes, which are embodied separately from associated electronics. An influence of the connecting cable between measuring probe and electronics on the measured variable evaluation, for example, drift caused by the connecting cable, is significantly decreased. The connecting cable must, for example, only be shielded with ground.

In an embodiment, the measuring probe is operated in a conductive and in a capacitive measuring mode. Of concern, thus, is a multisensor, which is suitable both for capacitive as well as also for conductive process variable determination. In such case, the two measurement modes can be performed in the first and/or second operating mode. Both measurement modes can be performed alternately, at the same time, or, in each case, at predeterminable points in time.

In an additional embodiment, the first and/or second excitation signals are/is composed of two signal parts. In such case, a first signal part can be selected for application with the capacitive measuring mode and a second signal part for application with the conductive measuring mode. In this connection, reference is made to DE102014107927A1, which describes use of an excitation signal composed of two signal parts for implementing a capacitive and conductive multisensor.

Advantageously, the first and/or second excitation signals are/is, at least at times, a rectangular signal, a sine signal, a triangular signal, or a trapezoidal signal.

In an embodiment, the first and second excitation signals can be the same, i.e. the same excitation signal is used for the ground referenced and the non ground referenced operating mode. In other embodiments, however, also different excitation signals can be used.

It is, moreover, advantageous that the first and second excitation signals be so selected that they have the same arithmetic average value.

A preferred embodiment of the method of the invention provides that an impedance between the first and second electrodes is registered based on the first received signal. Advantageously in the first operating mode, in contrast, other impedances, for example, between an electrode and ground, do not enter into the first received signal. Such can rather be ascertained by means of the second received signal. Thus, the invention enables a complete determining of all impedances with a single sensor. This would not be possible in the case of application of only one of the two operating modes. It is, among other things, thus this exact characterizing by means of a single sensor, which leads to an especially high accuracy of measurement and a highly accurate accretion detection.

Another advantageous embodiment includes that the presence of an accretion on the measuring probe is determined based on the first and/or second received signals. The accretion determination by means of the method of the invention enables an exact judging of the accretion independently of the medium, especially the accretion thickness and the conductivity of the accretion.

The at least one process variable is, for example, a fill level or limit level of the medium in the containment, or a dielectric constant or a conductivity of the medium.

The method of the invention permits numerous variations. For example, different process variables can be ascertained in the different operating- and/or measurement modes. Moreover, certain sequences can be established for the different modes. Correspondingly, the following embodiments are to be seen as examples of possible embodiments, wherein the invention is not limited to the explicitly mentioned variants.

In an embodiment, when the medium has a conductivity below a predeterminable limit value, the process variable is ascertained based on the first received signal.

In an additional embodiment, when the medium has a conductivity above a predeterminable limit value, the process variable is ascertained based on the first and second received signals.

Another embodiment includes that the first and second operating modes are performed alternately.

In an especially preferred embodiment, in which the measuring probe has at least three electrodes, the method of the invention comprises method steps as follows:
in the first operating mode, supplying a first electrode of the measuring probe with a first excitation signal, wherein a second electrode of the measuring probe serves as receiving electrode, and wherein a first received signal is received by the measuring probe,
in the second operating mode, supplying the first or second electrode of the measuring probe with a second excitation signal, wherein a third electrode of the measuring probe serves as ground electrode, and wherein a second received signal is received by the measuring probe, and ascertaining the at least one process variable based on the first and/or second received signal.

In the case of a measuring probe with more than two electrodes, at least partially, different electrodes can serve for the two operating modes, especially as transmitting electrode, receiving electrode and/or ground electrode. Additionally, the most varied of measuring probe geometries can be used.

The choice of different electrodes for the two operating modes permits, furthermore, a fashioning of the electrode configuration specially for the different operating modes. For the first operating mode, the ground referenced operating mode, a separation between the first and second electrodes, for example, can be advantageously reduced, which, in turn, leads to an increased measuring sensitivity. This, in turn, improves the measuring performance especially for media with lower electrical conductivity, such as, for example, oils.

Advantageously, the second electrode serves at least in the second operating mode as guard electrode. The guard electrode is then preferably operated at the same potential as the first electrode, thus, the transmitting electrode.

The object of the invention is achieved, furthermore, by a device for determining and/or monitoring at least one process variable of a medium in a containment with at least one measuring probe, which measuring probe has at least two electrodes and which device is embodied to perform the method of the invention according to at least one of the described embodiments.

The device, especially the electronics, can be embodied especially analogously to the device described in DE102014107927A1.

It is to be noted here that the embodiments described in connection with the method of the invention can also be applied mutatis mutandis to the device of the invention.

The invention will now be described in greater detail based on the appended drawing, the figures of which show as follows:

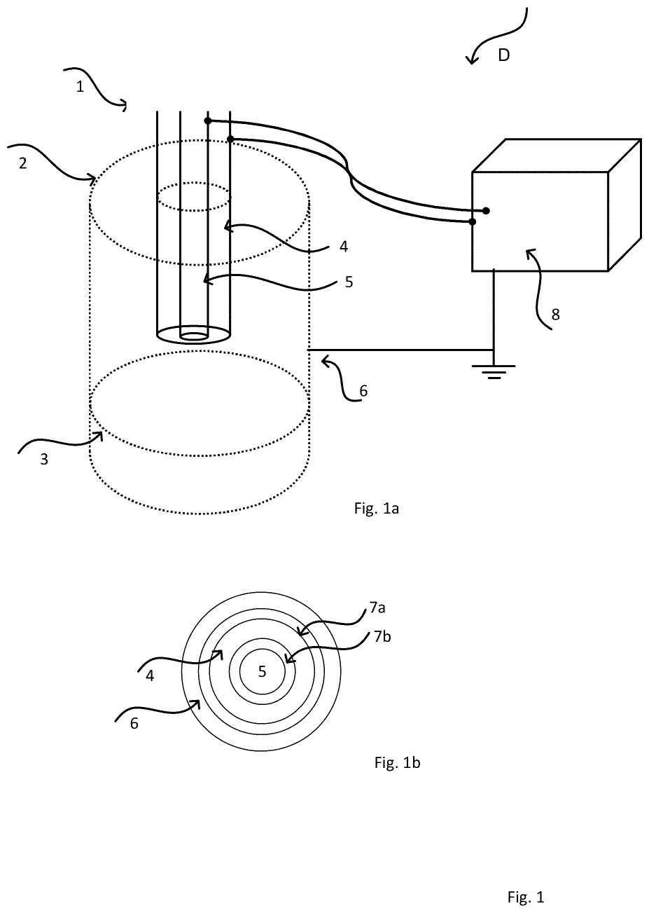

FIG. 1 by way of example, schematic views of a measuring probe for application with the method of the invention;

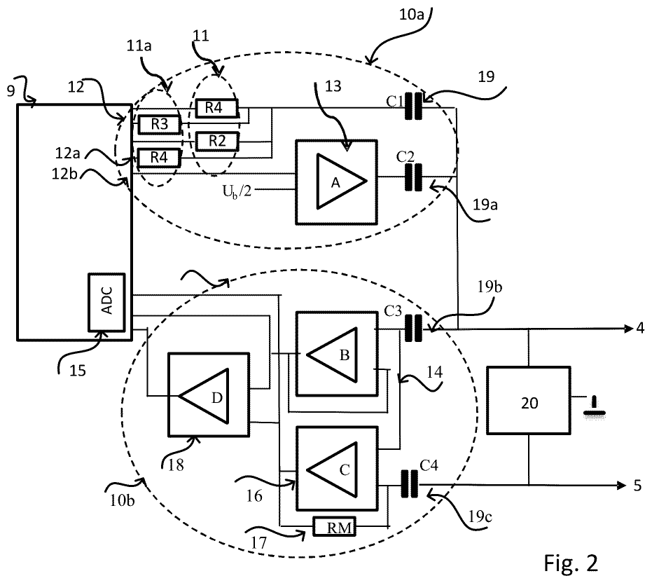

FIG. 2 a block circuit diagram of an electronics according to the state of the art;

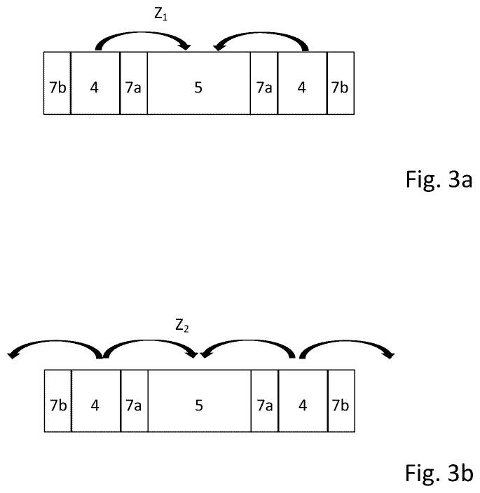

FIG. 3 sectional views of a measuring probe with two electrodes for explaining the two operating modes of the invention;

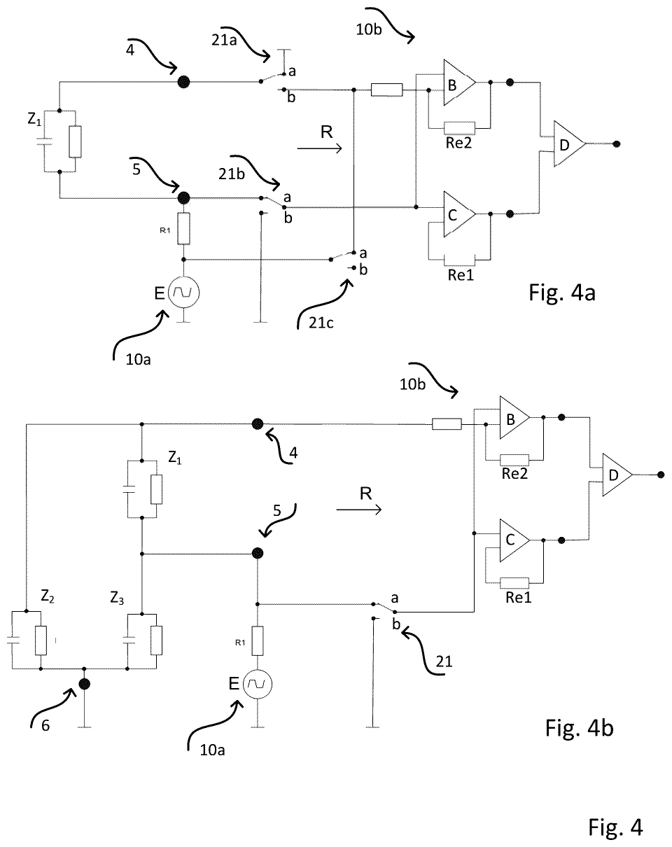

FIG. 4 block circuit diagrams of (a) the first and (b) the second operating mode of the method of the invention; and

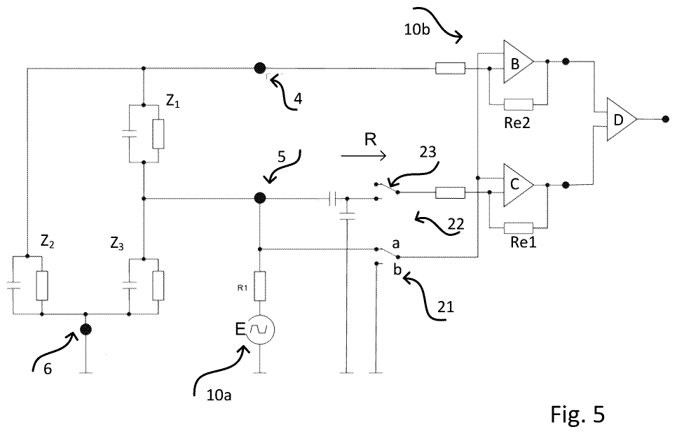

FIG. 5 a block circuit diagram as shown in FIG. 4b, however, having additional offset compensation.

FIG. 1a shows, by way of example, an embodiment of a measuring probe 1 of a field device D, by means of which a process variable can be monitored in the capacitive or conductive measuring method. Measuring probe 1 is arranged in a container 2, which is filled, at least partially, with a medium 3. In such case, measuring probe 1 extends from the top of the container into such. It is understood, however, that the measuring probe 1 can in other embodiments also be so embodied such that it terminates with the wall of the container 3.

The measuring probe 1 itself is composed in the present example of two electrodes, a first electrode 4 and a second electrode 5, which serves for preventing the formation of accretion. The container wall further forms a ground electrode 6. Measuring probe 1 is additionally connected with an electronics 8, which is responsible for signal registration, evaluation and/or supply. Especially, the electronics 8 ascertains the process variable based on the received signals.

FIG. 1b shows a sectional view of a measuring probe 1 with three electrodes 4,5,6. The electrodes 4,5,6 are electrically isolated from one another by insulation 7a,7b and arranged concentrically. Such an embodiment of a measuring probe 1 is especially advantageous for a flushly mounted measuring probe 1 terminating with the container wall.

FIG. 2 shows a block circuit diagram of an electronics 8, by means of which the measuring probe 1 can be operated both in the capacitive as well as also in the conductive operating mode. The invention is not limited to the shown electronics 8, but, rather, the shown embodiment is only one possible example of a suitable electronics 8. The electronics 8 of FIG. 2 corresponds to the electronics described in DE102014107927A1.

The shown electronics 8 includes a microcontroller 9 and is divided into a region 10a for producing the transmitted signal with different signal parts and into a region 10b for evaluating the received signals dependent on the signal parts.

Serving for producing a transmitted signal in the form of a rectangular signal for the conductive operating mode are two voltage dividers 11,11a, a low ohm dimensioned voltage divider (R1/R2) 11 for highly conductive media and a high voltage dimensioned divider (R3/R4) 11a for slightly conductive media. The activation of these two voltage dividers 11,11a occurs via corresponding port-outputs 12,12a of the microcontroller 9. In the example shown here, a triangular voltage generated via the operational amplifier integrator 13 (block A) is selected via an additional port-output 12b of the microcontroller as transmitted signal for the capacitive operating mode.

The region 10b for evaluating the received signals dependent on the signal parts includes the blocks B to D, wherein all three comprise operational amplifiers. Furthermore, in order to minimize the influence of parasitic effects and accretion formation on the measuring probe 1, the guard technology of DE00102008043412A1 can be applied.

Block B 14 includes an amplifier, which places the reference signal, in this case, the guard voltage, on the analog-digital converter (ADC) 15 of the microcontroller 9. B 14 can likewise be used to shield at least one circuit board.

Also block C 16 comprises an amplifier, which is responsible for delivering the received signal to the ADC 15. In addition, a measuring resistor 17 is provided, with which the difference between the voltages on the transmitting electrode and the guard electrode is determinable.

For evaluating the received signal won from the capacitive measuring, supplementally, block D 18 is necessary, which comprises a difference amplifier, in order to subtract and amplify the two signals received from the transmitting- and guard electrodes. This is accomplished via the measuring resistor 17. The difference between the two received signals is directly proportional to the capacitance of the measuring probe 1. With such an electronics 8, a measurement resolution of a few femtofarads is possible.

Shown, moreover, in the block circuit diagram of FIG. 2 are four decoupling capacitors 19, 19a, 19b, 19c, which filter the direct voltage parts from the signals. Finally shown is the ESD protection circuit 20. Also an offset compensation can be performed.

The two operating modes of the invention will now be explained in greater detail based on FIG. 3. Shown are sectional views of an electrode, such as shown in FIG. 1a, with a transmitting electrode 4, a receiving electrode 5, insulating layers 7a, 7b lying therebetween, and a ground electrode formed by the wall of the container 2.

In the first operating mode of FIG. 3a, the non ground referenced operating mode, the first electrode 4 serves as transmitting electrode and the second electrode 5 as receiving electrode. In this operating mode, the impedance Z₁ between the transmitting 4 and receiving electrode 5 can advantageously be ascertained.

In the second, ground referenced operating mode, the second electrode 5 serves, in contrast, as ground electrode. In this operating mode, the impedance Z₂ to ground can be ascertained. In the case of a measuring probe 1 with more than two electrodes, impedances to ground for a plurality of electrodes can be ascertained. The knowledge of all impedances Z leads to a significantly improved accuracy of measurement and to the opportunity to detect accretion in the region of the measuring probe 1 reliably and independently of the medium 3.

Shown in FIG. 4 are two block circuit diagram examples suitable for application for a measuring probe 1 with (a) two and (b) three electrodes 4-6. Of course, the method of the invention is, however, also implementable with other circuit arrangements. By way of example, the two block circuit diagrams of FIG. 4, without intending to limit the general applicability of the invention, lean on the electronics 8 of FIG. 2 with respect to the region 10b, and, likewise without intending to limit the general applicability of the invention, switching elements 21 are used for switching back and forth between the first operating mode and the second operating mode.

Shown in FIG. 4a are a region 10a for producing the excitation signal E, the electrodes 4 and 5, an equivalent circuit for the impedance Z₁ between the two electrodes 4,5 and the region 10b for evaluating the received signals R. Region 10b corresponds largely to the corresponding region of FIG. 2. Serving for changing between the two operating modes, the ground referenced operating mode a and the non ground referenced operating mode b are the three switching elements 21a-21c. The same excitation signal E can be used for the two operating modes or different excitation signals E₁ and E₂ can be used. In each case, one obtains for the two operating modes two different received signals R₁, R₂, which are designated in FIG. 4 with the reference character R.

In contrast with FIG. 4a, the measuring probe 1 using the block circuit diagram of FIG. 4b comprises three electrodes 4-6 and only a single switching element. In such case, the impedance Z₁ between the first 4 and second electrode 5, as well as the impedances Z₂ and Z₃ of the first 4 and second 5 electrodes to ground can be ascertained in the two different operating modes a and b.

FIG. 5 shows another example of a block circuit diagram, which corresponds to the block circuit diagram of FIG. 4b, but has, supplementally, an offset compensation 22. Offset compensation 22 serves for compensating other, in given cases, present, especially constant, parasitic effects, thus parasitic capacitances, between the measuring probe 1 and the container, or between individual electrodes 4-6 of the measuring probe 1. This serves for additionally improving measuring resolution.

By way of example, this unit 22 comprises according to the embodiment of FIG. 5 a plurality of capacitors, a resistance and a switching element 23 for operating or omitting the offset compensation. Of course, other means of offset compensation 22 can be used and fall within the scope of the invention.

### LIST OF REFERENCE CHARACTERS

1 measuring probe
2 containment
3 medium
4 first electrode
5 second electrode
6 third electrode
7 a, b insulation
8 electronics
9 microcontroller
10 a,b regions, respectively, for producing the transmitted signal and for evaluating the received signals
11 11a voltage dividers
12 12a port-outputs
13 block A, amplifier integrator
14 block B, amplifier
15 analog-digital converter (ADC)
16 block C, amplifier
17 measuring resistor
18 block D, difference amplifier
19 19a 19b 19c decoupling capacitors
20 ESD protection circuit
21 a-c switching elements for switching between operating modes
22 offset compensation
23 switching element
E E₁, E₂ excitation signals in the operating modes
R R₁, R₂ received signals in the operating modes
Z Z₁, Z₂, Z₃ impedances
a first operating mode
b second operating mode
D device

1-15. (canceled)

16. A method for determining and/or monitoring at least one process variable of a medium in a containment using a measuring probe having two electrodes, the method comprising:
in a first operating mode, supplying a first electrode of the measuring probe with a first excitation signal, wherein a second electrode of the measuring probe serves as a receiving electrode, and wherein a first received signal is received by the measuring probe;
in a second operating mode, supplying the first electrode of the measuring probe with a second excitation signal, wherein the second electrode of the measuring probe serves as a ground electrode, and wherein a second received signal is received by the measuring probe; and
determining the at least one process variable based on the first and/or second received signals.

17. The method as claimed in claim 16,
wherein the measuring probe is operated in a conductive and in a capacitive measuring mode.

18. The method as claimed in claim 16,
wherein the first and/or the second excitation signal is/are composed of two signal parts.

19. The method as claimed in claim 16,
wherein the first and/or second excitation signal are/is, at least at times, a rectangular signal, a sine signal, a triangular signal, or a trapezoidal signal.

20. The method as claimed in claim 16,
wherein the first and second excitation signals are the same.

21. The method as claimed in claim 16,
wherein the first and second excitation signals are so selected that they have the same arithmetic average value.

22. The method as claimed in claim 16, further comprising:
registering an impedance between the first and second electrodes based on the first received signal.

23. The method as claimed in claim 16, further comprising:
determining a presence of an accretion on the measuring probe based on the first and/or second received signal.

24. The method as claimed in claim 16,
wherein the at least one process variable is a fill level or limit level of the medium in the containment, or a dielectric constant or a conductivity of the medium.

25. The method as claimed in claim 16,
wherein, when the medium has a conductivity below a predeterminable limit value, the process variable is ascertained based on the first received signal.

26. The method as claimed in claim 16,
wherein, when the medium has a conductivity above a predeterminable limit value, the process variable is ascertained based on the first and second received signals.

27. The method as claimed in claim 16,
wherein the first and second operating modes are performed alternately.

28. The method as claimed in claim 16, further comprising:
in the first operating mode, supplying the first electrode with the first excitation signal, wherein the second electrode serves as receiving electrode, and wherein the first received signal is received by the measuring probe;
in the second operating mode, supplying the first or second electrode with the second excitation signal, wherein a third electrode of the measuring probe serves as ground electrode, and wherein the second received signal is received by the measuring probe; and
determining the at least one process variable based on the first and/or second received signal.

29. The method as claimed in claim 28,
wherein the second electrode serves as guard electrode in the second operating mode.

30. A device for determining and/or monitoring at least one process variable of a medium in a containment with at least one measuring probe, wherein the at least one measuring probe has at least two electrodes and wherein device is embodied to:
in a first operating mode, supply a first electrode of the measuring probe with a first excitation signal, wherein a second electrode of the measuring probe serves as a receiving electrode, and wherein a first received signal is received by the measuring probe;
in a second operating mode, supply the first electrode of the measuring probe with a second excitation signal, wherein the second electrode of the measuring probe serves as a ground electrode, and wherein a second received signal is received by the measuring probe; and
determine the at least one process variable based on the first and/or second received signals.
